(19) United States
(12) Patent Application Publication
(10) Pub. No.: US 2009/0061133 A1
(43) Pub. Date: Mar. 5, 2009

(54) TWO-PIECE CAN, METHOD FOR MANUFACTURING SAME, AND STEEL SHEET THEREFOR

(75) Inventors: Katsumi Kojima, Hiroshima (JP); Yuka Nishihara, Chiba (JP); Hiroshi Kubo, Hiroshima (JP); Yoshihiko Yasue, Hiroshima (JP); Yasuhide Oshima, Hiroshima (JP); Hiroki Iwasa, Hiroshima (JP)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: JFE Steel Corporation a corporation of Japan, Tokyo (JP)

(21) Appl. No.: 12/063,649

(22) PCT Filed: Aug. 10, 2006
(86) PCT No.: PCT/JP2006/316117

§ 371 Date: Feb. 12, 2008

(30) Foreign Application Priority Data
Aug. 12, 2005 (JP) 2005-234534
Aug. 12, 2005 (JP) 2005-234543
Aug. 12, 2005 (JP) 2005-234544

(51) Int. Cl. B32B 1/02; B65D 8/00; B21D 11/10

(52) U.S. Cl. 428/35.8; 220/669; 72/379.4

(57) ABSTRACT

A two-piece can has sufficient can strength and excellent corrosion resistance and to provide a method for forming the two-piece can easily without generating cracks. The two-piece can uses a laminated steel sheet as the base material and having a can body in a shape of cylinder integrated with bottom. The can body is treated by diametral reduction to become the diameter of opening side thereof smaller than the diameter of can body, and to satisfy the formulae (1) and (2). There is formed a bead at the opening side of the can body, being curled outward from the can at the tip of the opening in a shape of circular arc or vertically long ellipse in cross section, and is further formed a bead having a cross sectional shape of further curled at the tip thereof, an upper bead, and a lower bead:

1.5≦h/(R−r) (1)

d/R≦0.25 (2)

where, h is the height from the can bottom to the tip of the opening, R is the net blank radius, r is the radius of the can bottom, and d is the radius of the tip of the opening.

### RELATED APPLICATION

This is a §371 of International Application No. PCT/JP2006/316117, with an international filing date of Aug. 10, 2006 (WO 2007/020947 A1, published Feb. 22, 2007), which is based on Japanese Patent Application Nos. 2005-234534, filed Aug. 12, 2005, 2005-234543, filed Aug. 12, 2005 and Japanese Patent Application Nos. 2005-234544, filed Aug. 12, 2005.

### TECHNICAL FIELD

This disclosure relates to a two-piece can used for container of varieties of sprays, including metal container for aerosol.

### BACKGROUND ART

Metal containers for aerosol, for example, are largely grouped into three-piece can and two-piece can. The three-piece can has a structure of a can body prepared by joining edges of cylindrically-shaped rectangular sheet, and a can bottom and a can lid (dome top) attached to the respective ends of the can body. The name of the three-piece can comes from the three structural elements of the members. When the three-piece can is used for spraying, the dome top is further equipped with a mounting cap having an ejection valve, (when the term “mounting cap” is used hereinafter, the cap is equipped with the ejection valve). Therefore, when the mounting cap is counted, the number of structural members becomes four. Since, however, beverage cans and food cans which have a can body joining the edges of cylindrically-formed metal sheet are usually called the “three-piece cans”, the present invention also names the cans having above structure as the “three-piece cans”.

Two-piece can has a seamless can body, and is treated by diametral reduction in a range from the can body toward the mounting cap in smooth and continuous shape. Therefore, compared with the three-piece can, the two-piece can has superior beautifulness in appearance. As a result, two-piece can is widely adopted by the users emphasizing the appearance of package for appealing the product such as aromatic substance, antiperspirant, and hair conditioner. FIG. 1 and FIG. 2 show the cross sectional shapes of conventional two-piece cans. FIG. 1 shows the two-piece can having the bead in circular arc in cross section, and FIG. 2 shows the one having the bead in vertically long ellipse in cross section. FIGS. 1 and 2 show the can body 1, the mounting cap 2, the ejection valve 3, the bead 3, and the circular blank 5 before working.

The base material for three-piece can and two-piece can is steel sheet for the three-piece can, and the base material for two-piece can, illustrated in FIGS. 1 and 2, is aluminum. The two-piece can adopts aluminum as the base material because aluminum has higher corrosion resistance than that of steel sheet, and because the corrosion resistance to the contents and the rust-generation on outer face raise little problem under exposure of aerosol can to a humid environment. To the contrary, steel sheet has high strength and is inexpensive. Consequently, if steel sheet is applied to aerosol can which needs high pressure strength, the can sheet thickness can be reduced while assuring sufficient can strength, thereby decreasing the base material cost. From the above-consideration, a two-piece can made of a steel sheet having increased corrosion resistance is wanted, and there are studies of fabrication of two-piece cans using a high steel sheet having increased corrosion resistance.

For example, the methods for fabricating two-piece aerosol can using a steel sheet having increased corrosion resistance are disclosed in Japanese Patent Laid-Open No. 63-168238 in which the surface of steel sheet is laminated by a metal having high corrosion resistance, in Japanese Patent Laid-Open No. 9-39975 in which the surface of steel sheet is laminated by a coating film, and in Japanese Patent Laid-Open No. 1-228567 in which the surface of steel sheet is laminated by a film.

Since aluminum is softer than steel sheet, the impact forming, the drawing-redrawing forming, the drawing-redrawing-ironing forming, and the like are used to obtain the shape of aerosol can, specified in Federation of European Aerosol Association Standard No. 215, No. 219, and No. 220, for instance, to form the can body in a shape of cylinder integrated with bottom, and further to reduce the diameter at the opening end, thereby relatively easily working into the shape of aerosol can. Since, particularly for an aerosol can, the bead has to be formed to attach the mounting cap at the opening end of the can body, the working until forming the bead makes the material work-hardening, thus deteriorating the ductility. When steel sheet which shows larger work-hardening than aluminum does is used, cracks likely occur during forming of bead by the curling caused by poor ductility, and the forming of bead becomes extremely difficult.

To avoid the difficulty in working, Japanese Patent Laid-Open No. 63-168238, Japanese Patent Laid-Open No. 64-62232 and Japanese Patent Laid-Open No. 2004-276068 disclose the methods of forming the bead at the can bottom side, and Japanese Patent Laid-Open No. 50-129474 discloses the method of improving the bead-forming method.

Japanese Patent Laid-Open No. 63-168238 in which the surface of steel sheet is coated with a metal having high corrosion resistance discloses a technology which uses a steel sheet coated with aluminum, thereby avoiding the rust generation at the can bottom of two-piece aerosol can formed by drawing and ironing. The method may avoid rust generation at the can bottom where the degree of working is small. Since, however, the can body which is subjected to drawing and ironing suffers damage of aluminum coating, the rust generation may occur. Although Japanese Patent Laid-Open No. 63-168238 describes both the method in which the bead is formed at opening end side of the can body formed in a shape of cylinder integrated with bottom, and the method in which the bead is formed at the can bottom side. However, Japanese Patent Laid-Open No. 63-168238 does not specifically describe the forming of bead, which is difficult in conventional methods.

Japanese Patent Laid-Open No. 9-39975 which is the method of coating the surface of steel sheet by a lacquer layer discloses a technology relating to the inside-lacquered metal container having a cured polyamide-imide lacquer layer.

Although the technology is described to be able to use a steel sheet as the base material for two-piece aerosol can, the Examples relating to the steel sheet in the description are only for three-piece cans subjected to small degree of working, and there is no satisfactory description about the corrosion resistance for the steel sheet which is worked into two-piece can subjected to high degree of working, and the effect is not known. In addition, the specification describes that the technology can be applied either to the formed can body or to the metal sheet before working. However, for the case of applying the technology to an aluminum-made two-piece can, given in Examples, the lacquer coating after forming the can body is described, but there is no detail example of the case that the metal sheet before forming is coated with lacquer layer. To this point, according to the investigations conducted by the inventors of the present invention, when a steel sheet coated by a thermally cured lacquer layer was worked into a two-piece aerosol can subjected to a high degree of working, the lacquer layer was damaged by the working, thus failing to attain sufficient corrosion resistance. Furthermore, the Examples disclose only the two-piece can using aluminum, and there is no disclosure about the bead-forming using steel sheet.

In view of corrosion resistance, the method of laminating the surface of steel sheet by a film is a promising one. Japanese Patent Laid-Open No. 1-228567 discloses a technology of fabricating an aerosol can using also a steel sheet laminated by a biaxially oriented film of polyethylene terephthalate. Since the drawn can body is laminated by a not-damaged laminate film, the corrosion resistance is strong. However, the corrosion resistance on the can body obtained by the technology is maintained only for the can at a small working degree, receiving no diametral reduction at the opening end of the can body, as given in the Examples, and there is no consideration on the corrosion resistance on applying to the can worked into the shape of aerosol can, specified in Federation of European Aerosol Association Standard No. 215, No. 219, and No. 220. Similarly, the technology does not expect the forming of bead after diametral reduction of the can body.

Japanese Patent Laid-Open No. 10-24973 discloses a technology relating to an aerosol can which is fabricated by drawing a steel sheet laminated by a composite film composed of a polypropylene resin layer laminated on both sides of a vinylidene chloride resin layer via an acid-modified polyolefin resin, respectively. Since the technology uses a steel sheet laminated by a film, the can body having high corrosion resistance is expected to be obtained. For the method of drawing, however, detail description of working method is not given, only describing in Examples that an aerosol can having a shape of 45 mm in diameter and 120 mm in height was obtained, and no disclosure of the detail working method is given. In particular, no disclosure is given on the corrosion resistance after diametral reduction at the opening end of the can body, and on the forming of bead.

Forming of bead at the opening end of the cylinder integrated with bottom is difficult as described above. To this point, Japanese Patent Laid-Open No. 63-168238, Japanese Patent Laid-Open No. 64-62232 and Japanese Patent Laid-Open No. 2004-276068-disclose the method to form the bead at can bottom side. Since the can bottom side is a portion of small degree of working during working step, and since the work-hardening and the deterioration in ductility of material are small, the forming of bead at that portion is relatively easy. Since, however, the method attaches the can bottom of separate member to the can body by seaming, the beautiful appearance of two-piece can is deteriorated, thus the method is not necessarily a preferable one.

Japanese Patent Laid-Open No. 50-129474-discloses a method applying roll-working through the steps from the diametral reduction at the opening end side of the can body to the forming of bead. Use of successive deforming process by the roll working is expected as effective for forming work owing to easily avoiding crack generation at bead, and the like. Since, however, the successive deforming results in slow working speed of rolling work, and when the rolling work is applied to a wide zone containing the diametral reduction part, as in the case of Japanese Patent Laid-Open No. 50-129474, a long working time is required, and there arises a problem of deteriorated productivity of can body. Furthermore, when the rolling work is given to a laminated steel sheet which is advantageous in corrosion resistance over a wide zone as in the case of Japanese Patent Laid-Open No. 50-129474 and at a high degree of working, there arises a problem of damaging of film caused by a rolling work tool.

As described above, there was no available method of using a laminated steel sheet and forming the bead after the diametral reduction of the can body in a shape of cylinder integrated with bottom. Furthermore, when the cross sectional shape of the bead is not a simple circular arc but a flat ellipse, the forming work of the bead becomes further difficult. According to the conventional technologies, when forming a bead in a shape of flat ellipse in cross section, as illustrated in FIG. 2, the first stage of working is to form the bead in a circular shape by the curling method, and then the second stage of working is to re-form the bead to the target flat elliptical shape. FIG. 3 illustrates the conventional forming method of the bead in a shape of flat ellipse. According to FIG. 3, the radius of curvature of the curling in the first stage is required to select larger than the curvature of flat ellipse, which increases the degree of working at the tip of the curled part, thereby likely inducing crack at the portion.

It could therefore be advantageous to provide a two-piece can having sufficient can strength and high corrosion resistance using a laminated steel sheet which is high in strength, relatively inexpensive, and high in corrosion resistance, and to provide a forming method which easily manufactures the two-piece can without generating cracks.

### SUMMARY

Through our studies, we found the following: First, the can strength of two-piece can becomes sufficient at a low cost by using a laminated steel sheet high in strength, relatively inexpensive, and high in corrosion resistance as the base material of the two-piece aerosol can, and secondly, the forming of bead, which is difficult to form when steel sheet is used as the base material of the two-piece can, is actualized by the improvement in the structure of bead and in the forming method.

The present invention has been derived on the basis of above findings, and the essence of the present invention is the following. We therefore provide:

(1) A two-piece can made of a laminated steel sheet, having: a can bottom having a function of bottom plate and being positioned at lowermost end of the can; a cylindrical can body, which can body has an opening positioned at uppermost end of the can opposite to the can bottom at lowermost end of the can and has a diametral reduction part positioned at upper part of the can body and below the opening; and a bead which joins a cap outside the can and which is not integrated with the two-piece can with the opening positioned at uppermost end of the can body, wherein the can body is worked in diametral reduction at the opening side to a diameter smaller than the diameter of the can body, while satisfying the formulae (1) and (2), and wherein the bead formed at the opening side of the can body is a bead being curled outward from the can at the tip of the opening, and being curled in circular arc in cross section thereof, and further the bead is formed so as the tip of the curled bead to be curled in circular arc in cross section inside the former circular arc in cross section on the same cross sectional plane,

1.5≦h/(R−r) (1)

d/R≦0.25 (2)

where, h is the height from the can bottom to the tip of the opening, R is the net blank radius, r is the radius of the can bottom, and d is the radius of the tip of the opening.

(2) A two-piece can made of a laminated steel sheet having: a can bottom having a function of bottom plate and being positioned at lowermost end of the can; a cylindrical can body, which can body has an opening positioned at uppermost end of the can opposite to the can bottom at lowermost end of the can and has a diametral reduction part positioned at upper part of the can body and below the opening; and a bead which joins a cap outside the can and which is not integrated with the two-piece can with the opening positioned at uppermost end of the can body, wherein the can body is worked in diametral reduction at the opening side to a diameter smaller than the diameter of the can body, while satisfying the formulae (1) and (2), and wherein the bead formed at the opening side of the can body is a bead being curled outward from the can at the tip of the opening, and being curled in vertically long ellipse in cross section thereof, and further the bead is formed so as the tip of the curled bead to be curled in vertically long ellipse in cross section and so as the elliptically curled tip to be further curled in circular arc in cross section on the same cross sectional plane,

1.5≦h/(R−r) (1)

d/R≦0.25 (2)

where, h is the height from the can bottom to the tip of the opening, R is the net blank radius, r is the radius of the can bottom, and d is the radius of the tip of the opening.

(3) The two-piece can according to (1) or (2), further having the bead being formed to satisfy b1/d≦1.4, where d is the radius of the tip of the opening, and b1 is the outer diameter of the bead.

(4) A two-piece can made of a laminated steel sheet having: a cylindrical can body integrated with a bottom plate, which can body has an opening positioned at an end opposite to the can bottom; a mounting cap positioned above the can body; a bead which joins the mounting cap with the opening positioned at top of the can body, wherein the can body is worked in diametral reduction at the opening side to a diameter smaller than the diameter of the can body, while satisfying the formulae (1) and (2), and wherein the bead is formed so as the tip of the opening to be curled outward the can at the opening side of the can body, and further to be curled in vertically long ellipse in cross section on the same cross sectional plane,

1.5≦h/(R−r) (1)

d/R≦0.25 (2)

where, h is the height from the can bottom to the tip of the opening, R is the net blank radius, r is the radius of the can bottom, and d is the radius of the tip of the opening.

(5) The two-piece can according to (4), further having the bead being formed to satisfy b1/d≦1.4, where d is the radius of the tip of the opening, and b1 is the outer diameter of the bead.

(6) A two-piece can made of a laminated steel sheet having: a can bottom having a function of bottom plate and being positioned at lowermost end of the can; a cylindrical can body, which can body has an opening positioned at uppermost end of the can opposite to the can bottom at lowermost end of the can and has a diametral reduction part positioned at upper part of the can body and below the opening; a bead which joins a cap outside the can and which is not integrated with the two-piece can with the opening positioned at uppermost end of the can body, wherein the can body is worked in diametral reduction at the opening side to a diameter smaller than the diameter of the can body, while satisfying the formulae (1) and (2), and wherein the bead comprises: an upper bead formed at the opening side of the can body and formed by curling the tip of the opening outward from the can; and a lower bead being connected to the root of the upper bead and being formed below an adjacent position to the upper bead by bulging outside the can in arc shape in cross section,

1.5≦h/(R−r) (1)

d/R≦0.25 (2)

where, h is the height from the can bottom to the tip of the opening, R is the net blank radius, r is the radius of the can bottom, and d is the radius of the tip of the opening.

(7) The two-piece can according to (6), further having the upper bead being formed to satisfy b1/d≦1.4, where d is the radius of tip of the opening and b1 is the outer diameter of the upper bead.

(8) The two-piece can according to (7), further having the lower bead being formed to satisfy b2/b1=1, where b1 is the outer diameter of the upper bead and b2 is the outer diameter of the lower bead.

(9) The two-piece can according to any of (1), (2), (4), and (6), wherein the laminated steel sheet is a steel sheet laminated by a polyester resin.

(10) The two-piece can according to (9), wherein the polyester resin is prepared by polycondensation of a dicarboxylic acid component and a diol component, wherein the dicarboxylic acid component contains terephthalic acid as the main ingredient, and the diol component contains ethylene glycol and/or butylene glycol as the main ingredient.

(11) The two-piece can according to (10) further having an organic resin as the laminate of the laminated steel sheet, which organic resin contains a two-piece can polyester resin as the main phase, and a resin which is incompatible and has 5° C. or lower Tg as the sub-phase. (Note: The glass transition is a phenomenon that a polymer substance changes the glassy hard state to a rubber-like state when it is heated. The temperature of occurrence of glass transition is called the “glass transition point (Tg)”).

(12) The two-piece can according to (11), wherein the resin existing as the sub-phase is a resin selected from the group consisting of: polyethylene, an acid modification thereof, an ionomer thereof, polypropylene, an acid modification thereof, and an ionomer thereof.

(13) A laminated steel sheet for two-piece can, having an organic resin film as the laminate for forming the two-piece can according to any of (1), (2), (4), and (6).

(14) A method for forming two-piece can made of a laminated steel sheet, having the steps of: forming a can body in a shape of cylinder integrated with bottom by applying repeated several cycles of drawing to a circular blank; applying diametral reduction to the can body at the opening side to a diameter smaller than the diameter of the can body, while satisfying the formulae (1) and (2); and forming a bead by forming a first curled part by curling the tip of the opening of the can body outward from the can in circular arc in cross section, followed by forming a second curled part by curling the tip of the opening containing the first curled part in circular arc in cross section,

1.5≦h/(R−r) (1)

d/R≦0.25 (2)

where, h is the height from the can bottom to the tip of the opening, R is the net blank radius, r is the radius of the can bottom, and d is the radius of the tip of the opening.

(15) The method for forming two-piece can made of a laminated steel sheet, having the steps of: forming a can body In a shape of cylinder integrated with bottom by applying repeated several cycles of drawing to a circular blank; applying diametral reduction to the can body at the opening side to a diameter smaller than the diameter of the can body, while satisfying the formulae (1) and (2); and forming a bead by forming a first curled part by curling the tip of the opening of the can body outward from the can in circular arc in cross section, followed by forming a second curled part by curling the tip of the opening containing the first curled part in circular arc in cross section, and then by pressing the curled part inward into the can to create a vertically long ellipse in cross section,

1.5≦h/(R−r) (1)

d/R≦0.25 (2)

where, h is the height from the can bottom to the tip of the opening, R is the net blank radius, r is the radius of the can bottom, and d is the radius of the tip of the opening.

(16) A method for forming two-piece can made of a laminated steel sheet, having the steps of: forming a can body in a shape of cylinder integrated with bottom by applying repeated several cycles of drawing to a circular blank; applying diametral reduction to the can body at the opening side to a diameter smaller than the diameter of the can body, while satisfying the formulae (1) and (2); and forming a bead by forming a first curled part by curling the tip of the opening of the can body outward from the can in circular arc in cross section, followed by forming a second curled part in vertically long ellipse in cross section by pressing the tip of the opening of the first curled part downward toward the can bottom,

1.5≦h/(R−r) (1)

d/R≦0.25 (2)

where, h is the height from the can bottom to the tip of the opening, R is the net blank radius, r is the radius of the can bottom, and d is the radius of the tip of the opening.

(17) A method for forming two-piece can made of a laminated steel sheet, having the steps of: forming a can body in a shape of cylinder integrated with bottom by applying repeated several cycles of drawing to a circular blank; applying diametral reduction to the can body at the opening side to a diameter smaller than the diameter of the can body, while satisfying the formulae (1) and (2); and, on forming a bead, forming an upper bead at the opening side of the can body so as the tip of the opening to be curled outward from the can, and forming a lower bead connecting to the root of the upper bead so as the lower bead to bulge outward from the can in arc in cross section below the upper bead, thus obtaining the two-piece can,

1.5≦h/(R−r) (1)

d/R≦0.25 (2)

where, h is the height from the can bottom to the tip of the opening, R is the net blank radius, r is the radius of the can bottom, and d is the radius of the tip of the opening.

(18) The method according to any of (14), (15), (16), and (17), further having the step of forming the upper bead satisfying b1/d≦1.4, where d is the radius of the tip of the opening, and b1 is the outer diameter of the bead.

(19) The method according to (17), further having the step of forming the lower bead satisfying b2/b1=1, where b1 is the outer diameter of the upper bead and b2 is the outer diameter of the lower bead.

(20) The method according to any of (14), (15), (16), and (17), wherein the laminated steel sheet is a steel sheet laminated by a polyester resin.

(21) The method according to (20), wherein the polyester resin is prepared by polycondensation of a dicarboxylic acid component and a diol component, wherein the dicarboxylic acid component contains terephthalic acid as the main ingredient, and the diol component contains ethylene glycol and/or butylene glycol as the main ingredient.

(22) The method according to (21) further having an organic resin as the laminate of the laminated steel sheet, which organic resin contains the polyester resin as the main phase, and a resin which is incompatible and has 5° C. or lower Tg as the sub-phase.

(23) The method according to (22), wherein the resin existing as the sub-phase is a resin selected from the group consisting of: polyethylene, an acid modification thereof, an ionomer thereof, polypropylene, an acid modification thereof, and an ionomer thereof.

(24) The method according to any of (14), (15), (16), and (17), wherein the forming method of two-piece can made of the laminated steel sheet includes ironing adding to the deep drawing.

(25) The two-piece can according to any of (1), (2), (4), and (6), wherein the steel sheet as the substrate of the laminated steel sheet contains at least one of the following:

(1) a steel sheet of a low carbon steel of approximate range from 0.01 to 0.10% C, being prepared by recrystallization annealing by box annealing;

(2) a steel sheet of a low carbon steel of approximate range from 0.01 to 0.10% C, being prepared by recrystallization annealing by continuous annealing;

(3) a steel sheet of a low carbon steel of approximate range from 0.01 to 0.10% C, being prepared by recrystallization annealing by continuous annealing, followed by over-aging;

(4) a steel sheet of a low carbon steel of approximate range from 0.01 to 0.10% C, being prepared by recrystallization annealing by box annealing or continuous annealing, followed by secondary cold-rolling (cold-rolling after annealing); and

(5) an IF steel (interstitial free steel) of a very low carbon steel of approximate range of 0.003% or less C with the addition of solid-solution C-fixing element, prepared by recrystallization by continuous annealing.

(26) The method according to any of (14), (15), (16), and (17), wherein the diametral reduction of the laminated steel sheet is at least one of die-curling method and spinning method.

### BRIEF DESCRIPTION OF THE DRAWINGS

FIG. 1 shows an example of conventional aluminum-made two-piece can in side view and longitudinal cross sectional view, (an example of circular arc in cross section).

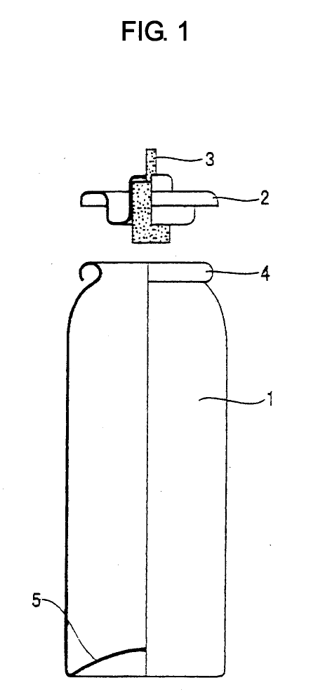

FIG. 2 shows another example of conventional aluminum-made two-piece can in side view and longitudinal cross sectional view, (an example of vertically long ellipse in cross section).

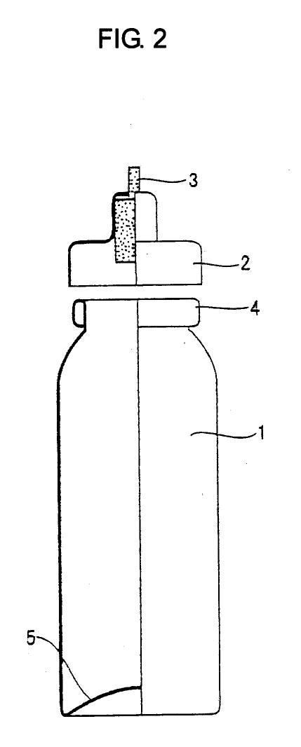

FIG. 3 shows a method for forming the bead for conventional aluminum-made two-piece can, (an example of forming method of the bead in flat elliptical shape).

FIG. 4 shows the relation of dimensions of our cans.

FIG. 5 shows an example of the method for forming the bead of the two-piece can.

FIG. 6 shows another example of the method for forming the bead for the two-piece can.

FIG. 7 shows further example of the method for forming the bead by die-curling method.

FIG. 8 shows still another example of the method for forming the bead of the two-piece can, (ellipse).

FIG. 9 shows an example of two-piece can in a state that the mounting cap is clinched to the bead, giving a side view and a longitudinal cross sectional view, (different in the bead tip shape).

FIG. 10 shows another example of the bead of the two-piece can.

FIG. 11 shows other example of the method for forming the bead of the two-piece can, (upper and lower beads).

FIG. 12 shows another example of the two-piece can in a state that the mounting cap is clinched to the bead, giving a side view and a longitudinal cross sectional view.

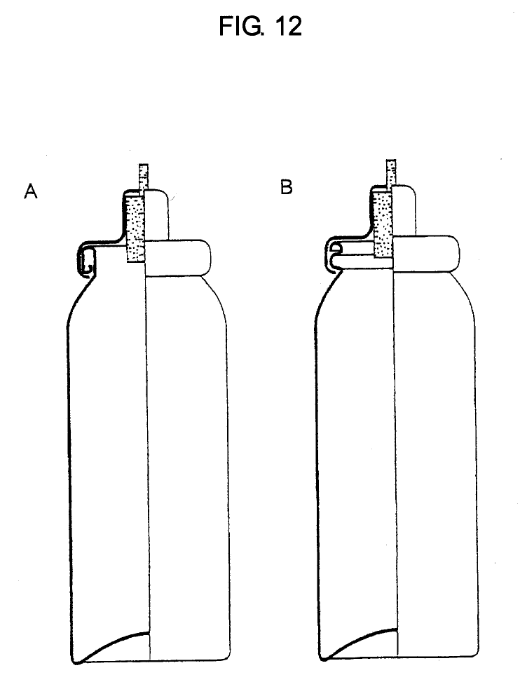

FIG. 13 shows still other example of the method for forming the bead of two-piece can by spinning working.

### DETAILED DESCRIPTION

The two-piece can and the method for forming thereof, and the steel sheet for two-piece can are described in detail below.

The description begins with the laminated steel sheet used as the base material to obtain a two-piece can which has sufficient corrosion resistance and strength as the can, and which is manufactured at a low cost. The base material for forming the two-piece can adopts a laminated steel sheet having the laminate of an organic resin film which has high workability and high corrosion resistance.

Although the steel sheet as the substrate of the laminated steel sheet is arbitrary if only the sheet can be formed into a target shape, preferable ones have the compositions given below and are manufactured by the method given below.

(1) a steel sheet of a low carbon steel of approximate range from 0.01 to 0.10% C, being prepared by recrystallization annealing by box annealing;

(2) a steel sheet of a low carbon steel of approximate range from 0.01 to 0.10% C, being prepared by recrystallization annealing by continuous annealing;

(3) a steel sheet of a low carbon steel of approximate range from 0.01 to 0.10% C, being prepared by recrystallization annealing by continuous annealing, followed by over-aging;

(4) a steel sheet of a low carbon steel of approximate range from 0.01 to 0.10% C, being prepared by recrystallization annealing by box annealing or continuous annealing, followed by secondary cold-rolling (cold-rolling after annealing); and

(5) an IF steel (interstitial free steel) of a very low carbon steel of approximate range of 0.003% or less C with the addition of a powerful solid-solution C-fixing element such as Nb and Ti, prepared by recrystallization annealing by continuous annealing. The mechanical characteristics of the steel sheet are not specifically limited if only the steel sheet can be formed into a target shape. To maintain sufficient can strength while not deteriorating the workability, however, the yield strength (YS) is preferably in an approximate range from 220 to 580 MPa. Also, for the r value which is an index of plastic anisotropy, 0.8 or higher value is preferred, and the planar anisotropy Δr of the plastic anisotropy r value is preferably 0.7 or less of the absolute value. The thickness of the steel sheet can be adequately selected depending on the shape of the target can and the necessary can strength. The sheet thickness is preferably in an approximate range from 0.15 to 0.4 mm to suppress the cost increase in the steel sheet and in the can.

The steel sheet preferably adopts a surface-treated steel sheet using various types of surface treatments. In particular, an optimum one is the surface-treated steel sheet, forming double layer films, namely metallic chromium at lower layer and chromium hydroxide at upper layer, (what is called the “TFS”). Although the coating weight of the metal chromium layer and the chromium hydroxide layer for the TFS is not specifically limited, it is preferable to select the range from 70 to 200 mg/m² as Cr for the metal chromium layer, and from 10 to 30 mg/cm² as Cr for the chromium hydroxide layer.

The organic resin film laminating the steel sheet is as follows.

The organic resin film structuring the laminated steel sheet is preferably the following to eliminate the possibility of damaging the film during working step as far as possible.

For example, a more preferable organic resin is polyester owing to the superior balance of elongation characteristic and strength characteristic, which balance is necessary for working. Preferable polyester resins include the one prepared by polycondensation of carboxylic acid component and diol component, wherein the dicarboxylic acid component contains terephthalic acid as the main ingredient, and the diol component contains ethylene glycol and/or butylene glycol as the main ingredient. When the terephthalic acid is the main ingredient of the dicarboxylic acid component, isophthalic acid ingredient may be added as other copolymerizing ingredient. For the diol component, when ethylene glycol and/or butylene glycol is the main ingredient, diethylene glycol and cyclohexane diol may be added as other copolymerizing ingredient. Furthermore, while using that type of polyester resin as the main phase, a resin which is incompatible and has 5° C. or lower Tg may be added as the sub-phase. In that case, the sub-phase preferably selects at least one of polyethylene, polypropylene, and/or an acid modification thereof, and an ionomer thereof.

A additive such as pigment, lubricant, and stabilizer may be added to the resin composition specified by the present invention, and, adding to the resin layer, a resin layer having other functions may be placed as upper layer or interim layer.

The method for laminating the steel sheet is not specifically limited, and an adequate method can be selected, such as thermocompression bonding process for thermocompression of biaxially oriented film or non-oriented film, and extrusion process which uses a T-die or the like to directly form the resin layer on the steel sheet. Those processes were confirmed to give sufficient effect.

### FIRST EMBODIMENT

The two-piece can of the First Embodiment is formed by the steps of: using the laminated steel sheet as the base material; forming a can body in the shape of a cylinder integrated with a bottom by applying repeated cycles of drawing to a circular blank; applying diametral reduction to the can body at the opening side to a diameter smaller than the diameter of the can body, while satisfying the formulae (1) and (2); and preparing a bead on the can body.

Particularly in the First Embodiment, the bead is formed by forming a first curled part by curling the tip of the opening of the can body outward from the can in a circular arc in cross section, followed by forming a second curled part by curling the tip of the opening containing the first curled part in a circular arc in cross section. Alternatively, the bead is formed by forming a first curled part by curling the tip of the opening of the can body outward from the can in an arc in cross section, followed by forming a second curled part by curling the tip of the opening containing the first curled part in circular arc in cross section, and then by pressing the curled part inward into the can to create a vertically long ellipse in cross section.

1.5≦h/(R−r) (1)

d/R≦0.25 (2)

where, h is the height from the can bottom to the tip of the opening, R is the circular blank positioning radius, r is the radius of the can bottom, and d is the radius of the tip of the opening.

The forming method is described in detail below.

(Forming can Body in a Shape of Cylinder Integrated with Bottom)

To form a can body in a shape of a cylinder integrated with a bottom from a base material of laminated steel sheet, a suitable method is the one to apply repeated cycles of drawing to a circular blank, thus to obtain a desired height. The number of drawing cycles and the drawing rate in the pluralities of drawing works can be adequately selected. To simplify the forming process, a small number of drawing cycles is preferred. To do this, however, low drawing rate, or severe working, is required. For simplifying the forming process, 10 or fewer number of drawing cycles is preferred. A preferable drawing rate is 0.4 or more for the first drawing cycle of the circular blank, and 0.5 or more for succeeding drawing (redrawing) cycles.

The drawing in the First Embodiment basically adopts a plurality of drawing cycles. There may be adopted a method adding ironing, or drawing-ironing working.

(Note: The term “ironing” is the work of, aiming to obtain a deep product by further thinning the formed cylindrical article prepared by deep-drawing, ironing the side wall of the non-deep-drawn formed article in the height-direction.)

In the plurality of drawing cycles, there can be adopted a wall-thinning drawing which decreases the sheet thickness utilizing bending and unbending deforming at the drawing die shoulder in a state of applying back-tension under the blank-holding force, a wall-thinning drawing and ironing working which adds ironing to the above working, and the like.

Drawing is affected by lubrication condition. For the laminated steel sheet, the laminate film is soft and has a smooth surface so that the film itself functions to increase the lubricant property. Therefore, drawing does not need special lubricant. In the case of low drawing rate, however, a lubricant is preferably adopted. The kind of lubricant is adequately selected.

During drawing, the sheet thickness of the side wall of the can body varies from the original sheet thickness. When the variation of sheet thickness is expressed by an average sheet thickness change rate t/t₀, (t is the average sheet thickness over the entire can height, and to is the original sheet thickness), the drawing-redrawing work likely gives t/t₀>1, while the drawing-ironing, the wall-thickness thinning-drawing, the wall-thickness thinning-drawing-ironing, and the like tend to give t/t₀<1. When the damage of laminated steel sheet during working is considered, the average sheet thickness change rate is preferably regulated in a range of 0.5<t/t₀<1.5.

### (Diametral Reduction at Opening Side of the can Body)

In an aerosol can, for example, to attach the mounting cap to the opening of the can body, the opening end has to be worked by diametral reduction to a diameter smaller than the diameter of the can body. The degree of working of the diametral reduction may be the one for attaining a specific diameter necessary to attach the mounting cap. From the point of eliminating the damage of film as far as possible, however, the relation between the radius r of the can body and the radius d of the opening end after diametral reduction is preferably d/r>0.3, and more preferably d/r>0.4. Applicable methods of diametral reduction include the die-neck method which conducts diametral reduction by pressing the opening end against a die in internal-taper shape, and the pin-neck method which conducts diametral reduction by pressing a rotary tool against the opening end of the can body in the inward radial direction of the can body. From the viewpoint of eliminating the film damage as far as possible, the die-neck method is suitable. As for the die-neck method, it is preferable that working is performed in several stages between the radius r of the can body and the radius d thereof after the final diametral reduction. If the degree of working per stage is large, the possibility of generating wrinkles during the diametral reduction increases. Therefore, the diametral reduction rate, (the diameter after diametral reduction/the diameter before diametral reduction), is preferably regulated to 0.9 or more. Since the film as the laminate of the laminated steel sheet is soft and has a smooth surface, the film itself functions to increase the lubricant property. Consequently, the diametral reduction does not need special lubricant. However, from the point of eliminating film damage caused by sliding with a tool, as far as possible, a lubricant is preferably applied. The type of lubricant is adequately selected.

Forming is requested for the degree of working after diametral reduction to satisfy the formulae (1) and (2).

1.5≦h/(R−r) (1)

d/R≦0.25 (2)

where, h is the height from the can bottom to the tip of the opening, R is the net blank radius, r is the radius of the can bottom, and d is the radius of the tip of the opening.

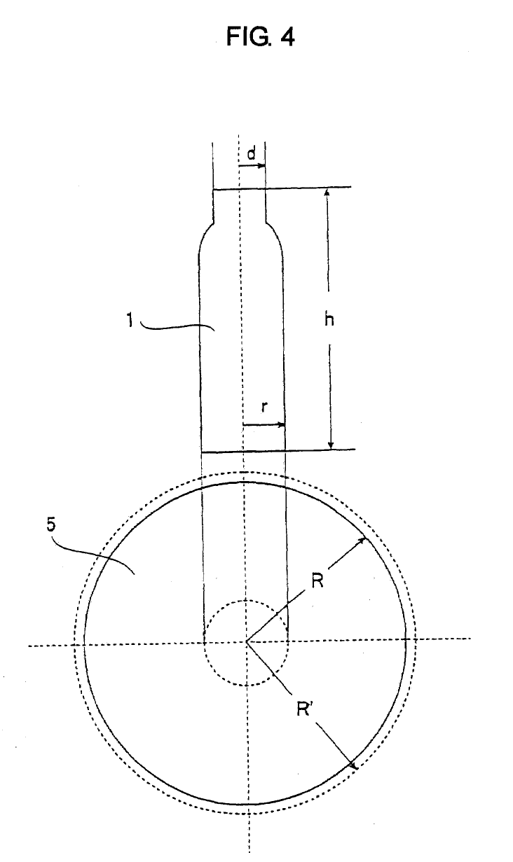

First, the relation among the height h up to the opening end, the bottom radius r, and the net blank radius R is specified to 1.5≦h/(R−r). FIG. 4 shows the relation of dimensions of the can, giving the can body 1 and the circular blank 5 before working. The symbols h, R, r, and d are described above. The symbol R′ is the original blank radius before trimming.

On actual drawing, the drawing is conducted from a circular blank having an original blank radius R′ larger than the net blank radius R specified by the present invention. The member between R and R′ is eliminated by trimming. The term (h/(R−r)) is an index representing average elongation of the laminated steel sheet in the can height direction before and after forming.

Then, the relation between the radius d at the tip of the opening and the net blank radius R is specified to d/R≦0.25. This is an index representing reduction of the laminated steel sheet in the can circumferential direction at the opening end before and after forming.

As described before, for forming a can body in the shape of a cylinder integrated with a bottom from the base material of laminated steel sheet, the method of applying a plurality of drawing cycles to the circular blank to obtain a specified height is suitable. In that case, to obtain the shape of aerosol can described in Federation of European Aerosol Association Standard No. 215, No. 219, and No. 220, and to avoid the damage of laminated steel sheet during working, the average sheet thickness change rate is regulated to 0.5<t/t₀<1.5. Then, it is required to establish the relation of 1.5≦h/(R−r) and d/R≦0.25.

(Trimming after Diametral Reduction)

In the working of diametral reduction on the opening side of the can body in the shape of a cylinder integrated with a bottom to a diameter smaller than the diameter of the can body, the material is compressed in the circumferential direction, which may generate fine surface irregularities at the opening end. The irregularities have a possibility of becoming the origin of cracks during succeeding curling work for forming the bead. Therefore, from the point of prevention of crack generation, it is effective to remove the opening end showing irregular surface by trimming, in advance, to make the surface of the opening end smooth. That is, applying trimming after diametral reduction can avoid the defects such as crack generation during forming of the bead.

### (Forming the Bead)

In the First Embodiment, the bead is formed by forming a first curled part by curling the tip of the opening of the can body outward of the can in a circular arc in cross section, followed by forming a second curled part by curling the tip of the opening containing the first curled part in a circular arc in cross section. Alternatively, the bead is formed by forming a first curled part by curling the tip of the opening of the can body outward from the can in a circular arc in cross section, followed by forming a second curled part by curling the tip of the opening containing the first curled part in a circular arc in cross section, and then by pressing the curled part inward into the can to create a vertically long ellipse in cross section. The procedure is the most important element in the First Embodiment. By the procedure, the bead is formed without generating cracks, and the formed bead has a cross section of a circular or vertically long elliptical shape, which allows the mounting cap to clinch and fix to the can body, thereby allowing full functioning as the bead.

When the steel sheet is subjected to can-forming at a very high degree of working as in the case of conventional technologies, the steel sheet is hardened by work-hardening, and the ductility thereof deteriorates. Therefore, when the opening end is treated by curling to form the bead, the opening end generates cracks, and the bead could not form after the diametral reduction on the can body in the shape of a cylinder integrated with a bottom.

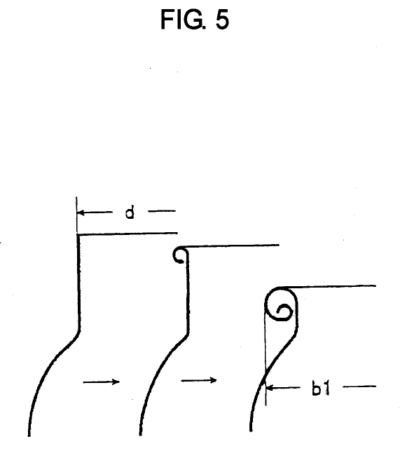

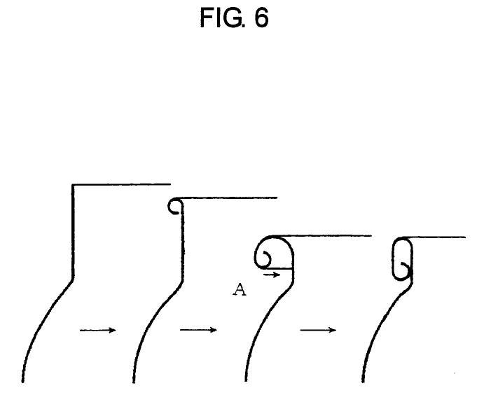

To this point, in the First Embodiment, there was found the method of forming a first curled part at the tip of the opening side of the can body, followed by forming a second curled part at the tip of the opening side including the first curled part. The forming process and the shape of the bead according to the First Embodiment are shown in FIGS. 5 and 6. FIG. 5 shows the radius d of the tip of the opening, and the radius b1 of the upper bead. According to FIG. 5, the first curled part curls outward from the can in a shape of a circular arc in cross section by a curling with a small curvature not to induce generation of cracks at the opening end. The second curled part curls in a circular shape in cross section at the tip of the opening side including the first curled part. The importance is that the first curled part is formed by curling at a small curvature not to induce cracks at the opening end side. In the case that the one curling work forms the bead having a target shape, the radius of curvature of the curling becomes large, which induces a danger of generation of cracks at the opening end of the can body during working. According to the First Embodiment, however, the first curled part is formed applying curling at a small curvature not inducing the generation of cracks at the opening end, followed by forming the second curled part so that the tip of the opening side including the first curled part to become the same size and the same cross sectional shape to the target size and shape. Consequently, the rigidity of the opening end increases, the extension of the opening end in the circumferential direction, which generates the cracks, is suppressed. Thus, no crack is generated even when curling is performed to the target size and cross sectional shape.

Referring to FIG. 6, the first curled part curls outward from the can in a shape of a circular arc in cross section by curling at a small curvature not to induce generation of cracks at the opening end. Then, the second curled part is, after curling the tip of the opening side including the first curled part in a circular shape in cross section, pressed inward into the can to become a vertically long ellipse in cross section. The reference symbol A designates the pressing direction. In conventional technologies, on forming the bead in flat ellipse in cross section, the first stage of working forms the circular bead by the curling, and the second stage of working re-forms the formed article into the target flat elliptical shape. In this case, the radius of curvature of the first stage curling is required to become larger than that of the flat ellipse, which increases the degree of working at the tip of the curled part, thereby further likely inducing cracks at the tip of the curled part. According to the First Embodiment, however, the first stage working forms the first curled part by curling of small curvature not to induce generation of cracks at the opening end, followed by forming the second curled part at the tip of the opening side including the first curled part. Consequently, the rigidity of the opening end increases, the extension of the opening end in the circumferential direction, which generates cracks, is suppressed, thus avoiding crack generation even during the curling. Furthermore, at the second stage working, the second curled part is pressed to form the bead in a flat elliptical shape in cross section while avoiding crack generation. Although the method for pressing the second curled part is not specifically limited, the spinning working utilizing a roll is preferable in view of accuracy of shape.

According to the First Embodiment, the bead is formed by curling at a small curvature not to induce generation of cracks during curling. In detail, the curling is preferably conducted under the condition of b1/d≦1.4, (d is the radius of the tip of the opening after diametral reduction, and b1 is the outer diameter of the upper bead). If the condition becomes b1/d>1.4, the cracks likely appear.

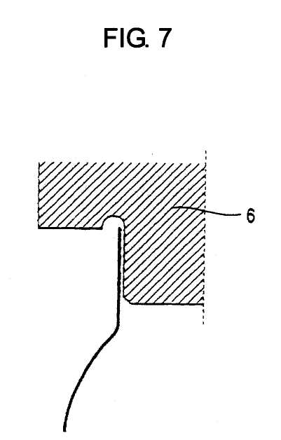

Applicable methods for curling include the die-curling method which presses the opening end of the can body against a curling die having a circular arc shape curved face at the root of the cylindrical insert, and the spinning method which presses the opening end of the can body against the roll having circular arc-shaped curved face. As a typical example, an outline of forming by die-curling method is illustrated in FIG. 7. FIG. 7 shows the curling die 6.

The above procedure provides the two-piece can. As needed, however, heat treatment and other working described below can be performed during the working process.

### (Heat Treatment During Working Process)

According to the First Embodiment, additional application of heat treatment during a series of working processes is effective as the method to decrease the possibility of film damage. That is, the stress on the film accompanied with the strain given to the film during working is relaxed by heat treatment, thereby decreasing the possibility of film separation during succeeding working steps. A suitable condition of the heat treatment for the purpose is the heat treatment at or above the glass transition point of the film and at or below the melting point +30° C., and more preferably, for the polyester film, 150° C. or above and the melting point +20° C. or below. Furthermore, it is preferable to apply rapid cooling to below the glass transition point of the film within 30 seconds after the heat treatment, more preferably within 10 seconds. The object of the heat treatment is relaxing the internal stress. Therefore, the heat treatment under the condition to relax the internal stress is required. The glass transition point is setup as the minimum temperature allowing relaxing the internal stress, and the value is the lower limit of the specification. In addition, for the polyester resin, 150° C. is set as the preferable lower limit of the heat treatment. The lower limit of the temperature allows conducting the treatment for a short time to relax the internal stress. That is, at or above the glass transition point, relaxation of internal stress is obtained, and at or above 150° C., the treatment within a short time is available. The upper limit of the heat treatment temperature is specified considering the deterioration of resin by thermal decomposition. Within the range of the melting point +30° C., preferably the melting point +20° C., the resin deterioration caused by thermal decomposition occurs very little. The method of heat treatment is not specifically limited, and it was confirmed that electric furnace, gas-oven, infrared furnace, induction heater, and the like give similar effect. The heating rate and the heating time are adequately selected depending on the effect. However, higher heating rate gives higher efficiency. Although an adequate range of the heating time is approximately from 15 to 60 seconds, the time is not necessarily limited to the range, and an adequate time is selected depending on the effect.

### (Other Working)

The aerosol can which is the target of the First Embodiment is required to have a pressure strength of 15 kgf/cm² or more to accept filling of propellant. For the pressure increase inside the can, special care shall be paid to the can bottom. The pressure inside the can body in a shape of cylinder integrated with bottom induces a stress on the side wall of the can body to stretch the can body in the circumferential direction. The member of the can body, however, has already become fully work-hardened by the drawing, thus the can body does not deform under the internal pressure. The portion which needs to consider the effect of the internal pressure is the can bottom. Since the can bottom is subjected to internal pressure in a state that the outer periphery is restricted by the can body, when the internal pressure is high, the can bottom deforms outward from the can. To suppress deformation of the can bottom under internal pressure, it is effective to increase the sheet thickness at the can bottom and to increase the strength of member, and further it is suitable to form the can bottom in a dome shape protruding inside of the can.

The structure of the bead specified in the First Embodiment is not limited to the case of laminated steel sheet as the can material but also applicable to the cases of other base materials.

### EXAMPLE 1-1

A low carbon cold-rolled steel sheet having 0.20 mm of thickness obtained by continuous annealing process was adopted as the TFS original sheet, which sheet was then laminated on both sides thereof by a polyethylene terephthalate film having 0.025 mm of thickness by the thermal fusion method to prepare a laminated steel sheet. The laminated steel sheet was formed into a circular blank having an original blank radius R′ of 42 mm. Then the blank was drawn at about 0.6 of the drawing rate. After that, four redrawing cycles at about 0.8 of the drawing rate were applied to form a can body in a shape of cylinder integrated with a bottom having an 11 mm radius r of the can body. After forming a dome protruding inside of the can body at the can bottom by stretch forming, heat treatment was applied to the can body at 220° C. for 30 seconds. Further, trimming was applied to the tip of the opening of the can body, followed by applying a plurality of diametral reduction cycles at about 0.95 of the diametral reduction by the die-neck method to obtain a 7.5 mm opening radius after the diametral reduction. After the diametral reduction, the opening end was further treated by trimming, thus forming a can having a 72 mm height h from the can bottom. The resulting net blank radius R became 40.3 mm, with the degree of working d/R in circumferential direction, of 0.19, and the degree of working h/(R−r) in the height direction of 2.24.

The first curled part of the can body was formed at the root of the cylinder insert using the die-curling method which presses the opening end of the can body against the curling die having a curved part in a circular arc shape with 1.0 mm of radius. The radius b1 of the front end of the outer diameter of the first curled part was 9 mm, and b1/d was 1.3. Furthermore, the second curled part was formed at the root of the cylinder insert by curling the tip of the opening including the first curled part in a circular arc in cross section using the die-curling method which presses the opening end of the can body against the curling die having a curved part in a circular arc shape with a 1.5 mm radius.

The above forming process did not generate cracks on forming particularly the bead. After storing the formed can at 50° C. and 98% RH for one month, no rust was generated. Consequently, the can did not generate cracks on forming the bead, and performed sufficient corrosion resistance also in a humid environment.

### EXAMPLE 1-2

A low carbon cold-rolled steel sheet having 0.20 mm of thickness obtained by continuous annealing process was adopted as the TFS original sheet, which sheet was then laminated on both sides thereof by a polyethylene terephthalate film having 0.025 mm of thickness by the thermal fusion method to prepare a laminated steel sheet. The laminated steel sheet was formed into a circular blank having an original blank radius R′ of 42 mm. Then, the blank was drawn at about 0.6 of the drawing rate. After that, four redrawing cycles at about 0.8 of the drawing rate were applied to form a can body in a shape of a cylinder integrated with a bottom having an 11 mm radius r of the can body. After forming a dome protruding inside of the can body at the can bottom by stretch forming, heat treatment was applied to the can body at 220° C. for 30 seconds. Further, trimming was applied to the tip of the opening of the can body, followed by applying a plurality of diametral reduction cycles at about 0.95 of the diametral reduction rate by the die-neck method to obtain a 7.5 mm opening radius d after the diametral reduction. After the diametral reduction, the tip of the opening was further treated by trimming, thus forming a can having a 72 mm height h from the can bottom. The resulted net blank radius R became 40.3 mm, with the degree of working d/R in the circumferential direction, of 0.19, and the degree of working h/(R−r) in the height direction of 2.24.

The first curled part of the can body was formed at the root of the cylinder insert using the die-curling method which presses the opening end of the can body against the curling die having a curved part in circular arc shape with a 1.0 mm radius. The radius b1 of the front end of the outer diameter of the first curled part was 9 mm, and b1/d was 1.3. Furthermore, the second curled part was formed at the root of the cylinder insert by curling the tip of the opening including the first curled part in a circular arc in cross section using the die-curling method which presses the opening end of the can body against the curling die having a curved part in a circular arc shape with a 2.1 mm radius. Then, applying spinning working using a roll to press the second curled part in the can internal direction, thus forming bead of flat ellipse in cross section. The outer diameter b2 of the bead was 10 mm, and the bead height which is the height between the upper end to the lower end of the bead was 4 mm.

The above forming process did not generate cracks on forming particularly the bead. After storing the formed can at 50° C. and 98% RH for one month, no rust was generated. Consequently, the can did not generate cracks on forming the bead, and performed sufficient corrosion resistance also in a humid environment.

### COMPARATIVE EXAMPLE

A low carbon cold-rolled steel sheet having a 0.20 mm thickness obtained by continuous annealing process was adopted as the TFS original sheet, which sheet was then laminated on both sides of TFS by a polyethylene terephthalate film having 0.025 mm of thickness by the thermal fusion method to prepare a laminated steel sheet. The laminated steel sheet was formed into a circular blank having an original blank radius R′ of 42 mm. Then, the blank was drawn at about 0.6 of the drawing rate. After that, four redrawing cycles at about 0.8 of the drawing rate were applied to form a can body in a shape of a cylinder integrated with a bottom having an 11 mm radius r of the can body. After forming a dome protruding inside of the can body at the can bottom by the stretch forming, heat treatment was applied to the can body at 220° C. for 30 seconds. Further, trimming was applied to the tip of the opening of the can body, followed by applying a plurality of diametral reduction cycles at about 0.95 of the diametral reduction rate by the die-neck method to obtain a 7.5 mm opening radius d after the diametral reduction. After the diametral reduction, the tip of the opening was further treated by trimming, thus forming a can having a 72 mm height h from the can bottom. The tip of the opening after the diametral reduction was further trimmed. Then, the root of the cylinder insert was treated by the die-curling method which presses the opening end of the can body against the curling die having a curved part in a circular arc shape with a 2.1 mm radius to curl to the radius of the tip b3 of 11.7 mm. The opening end of the can body generated cracks, and the bead could not be formed.

The two-piece can of the First Embodiment is most suitable for the two-piece aerosol can owing to the superior performance. Other than the two-piece aerosol can, the two-piece can of the First Embodiment is suitable for the uses which need can strength, corrosion resistance, good appearance, and low manufacturing cost.

### SECOND EMBODIMENT

The two-piece can, the method for manufacturing thereof, and the steel sheet for the two-piece can are described below in detail.

The laminated steel sheet as the base material applied in the Second Embodiment is the same to that in the First Embodiment.

The two-piece can of the Second Embodiment is formed by the steps of: using the laminated steel sheet as the base material; forming a can body in the shape of cylinder integrated with a bottom by applying repeated cycles of drawing to a circular blank; applying diametral reduction to the can body at the opening side to a diameter smaller than the diameter of the can body, while satisfying the formulae (1) and (2); and forming a bead on the can body. Particularly in the Second Embodiment, the bead is formed by forming a first curled part by curling the tip of the opening of the can body outward from the can in a circular arc in cross section, followed by forming a bead in the shape of a vertically long ellipse in cross section by pressing the tip of the opening side containing the first curled part downward toward the can bottom.

1.5≦h/(R−r) (1)

d/R≦0.25 (2)

where, h is the height from the can bottom to the tip of the opening, R is the net blank radius, r is the radius of the can bottom, and d is the radius of the tip of the opening.

The forming method is described in more detail below.

Forming the can body in the shape of a cylinder integrated with a bottom, diametral reduction at the opening side of the can body, and trimming after the diametral reduction are the same to those in the First Embodiment.

### (Forming the Bead)

In the Second Embodiment, the bead is formed by curling the tip of the opening outward from the can in a circular arc in cross section, followed by pressing the tip of the curled part downward toward the can bottom, thus obtaining the bead in a vertically long ellipse in cross section. The procedure is the most important element in the Second Embodiment. By the procedure, the bead is formed without generating cracks, and the formed bead has a cross section of a vertically long elliptical shape, which allows the mounting cap to clinch and fix to the can body, thereby allowing fully functioning as the bead.

When the steel sheet is subjected to can-forming at a high degree of working as in the case of conventional technologies, the steel sheet is hardened by work-hardening, and the ductility thereof deteriorates. Therefore, when the opening end is treated by curling to form the bead, the opening end generates cracks, and the bead could not be formed after applying diametral reduction to the can body in the shape of a cylinder integrated with bottom.

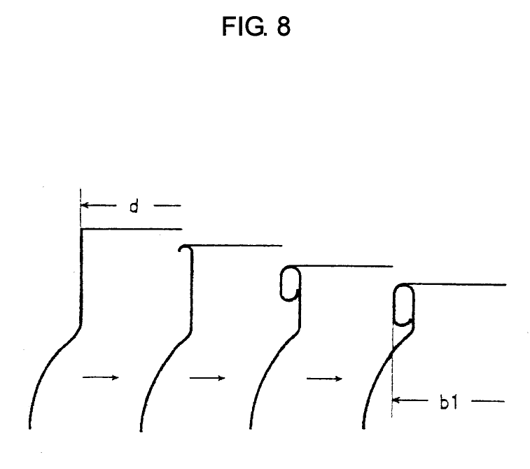

To this point, in the Second Embodiment, there was found the method of forming a bead in the shape of a vertically long ellipse in cross section at the tip of the opening by forming a curled part in the shape of a circular arc in cross section, followed by pressing the tip of the opening of the curled part downward toward the can bottom. FIG. 8 shows the forming process and the shape of the bead of the Second Embodiment. FIG. 8 shows the radius d of the tip of the opening, and the outer diameter b1 of the upper bead. According to FIG. 8, the first curled part in a shape of circular arc in cross section is formed by curling work at a small curvature not to induce generation of cracks at the opening end. Then, the tip of the opening of the first curled part is pressed downward toward the can bottom. The importance is that the forming is conducted by curling at a small curvature not to induce cracks at the opening end. In the case of forming the bead having the shape of a vertically long ellipse in cross section, conventional technologies form the bead having the shape of a circular arc by curling as the first stage working, followed by re-forming the bead into a target shape of a vertically long ellipse as the second stage working. In that case, the radius of curvature in the first stage curling has to be larger than that of the vertically long ellipse, which increases the degree of working at the tip of the curled part, thus more likely inducing crack generation at the portion. However, we form the first curled part by applying curling work at a small curvature not inducing the generation of cracks at the opening end, which avoids generation of cracks which appeared in the conventional technology on forming the circular arc shape bead by curling as the first stage working.

According to the Second Embodiment, the first curled part is formed by curling at a small curvature not to induce generation of cracks during curling. In detail, the curling is conducted preferably under the condition of b1/d≦1.4, (d is the radius of the tip of the opening after diametral reduction, and b1 is the outer diameter of the upper bead). If the condition becomes b1/d>1.4, the cracks likely appear.

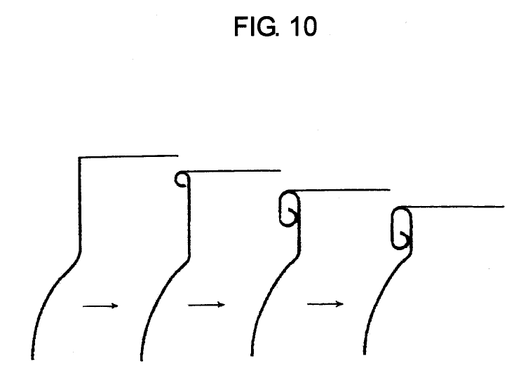

The method for curling is almost the same as that of the First Embodiment. However, on further pressing the first curled part as shown in FIG. 10, when a portion in the shape of a circular arc in cross section, formed in the first curling, is placed inside the vertically long ellipse, there attains the advantages of increased strength of the bead and of easy clinching work of the mounting cap to the bead. Alternatively, it is applicable that, after pressing the first curled part, a rotating roll is pressed against the can body from an outer side in the can radius direction to complete the cross sectional shape of the entire bead.

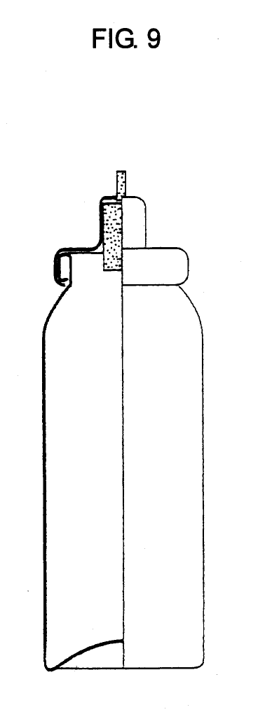

As shown in FIG. 9, since the bead has a structure aiming to fix the mounting cap to the can by clinching, the Second Embodiment adopts the shape of a vertically long ellipse in cross section for the bead.

The above procedure provides the two-piece can of the Second Embodiment. As needed, however, heat treatment and other working described in the First embodiment can be given during the working process.

The structure of the bead specified in the Second Embodiment is not limited to the case of a laminated steel sheet as the can material, but is also applicable to the cases of other base materials.

### EXAMPLE 2-1

A low carbon cold-rolled steel sheet having a 0.20 mm thickness obtained by the continuous annealing process was adopted as the TFS original sheet, which sheet was then laminated on both sides thereof by a polyethylene terephthalate film having a 0.025 mm thickness by the thermal fusion method to prepare a laminated steel sheet. The laminated steel sheet was formed into a circular blank having an original blank radius R′ of 42 mm. Then the blank was drawn at about 0.6 of the drawing rate. After that, four redrawing cycles at about 0.8 of the drawing rate were applied to form a can body in the shape of a cylinder integrated with a bottom having an 11 mm radius r of the can body. After forming a dome protruding inside of the can body at the can bottom by stretch forming, heat treatment was applied to the can body at 220° C. for 30 seconds. Further, trimming was applied to the tip of the opening of the can body, followed by applying a plurality of diametral reduction cycles at about 0.95 of the diametral reduction rate by the die-neck method to obtain a 7.5 mm opening radius d after the diametral reduction. After the diametral reduction, the tip of the opening was further treated by trimming, thus forming a can having a 72 mm height h from the can bottom. The resulting net blank radius R became 40.3 mm, with the degree of working d/R in the circumferential direction, of 0.19, and the degree of working h/(R−r) in the height direction of 2.24.

The first curled part of the can body was formed at the root of the cylinder insert using the die-curling method which presses the opening end of the can body against the curling die having a curved part in circular arc shape with a 1.0 mm radius. The radius b1 of front end of the outer diameter of the first curled part was 9 mm, and b1/d was 1.3. Furthermore, by applying the die-curling method which presses the opening end of the can body against the curling die having a curved part in a circular arc shape with a 1.25 mm radius, the tip of the opening side of the first curled part was pressed downward toward the can bottom, thus bringing the outer diameter b2 of the bead at the root of the cylinder insert to 10 mm. In that case, the bead height from upper end to lower end of the bead was 4 mm.

The above forming process did not generate cracks on forming particularly the bead. After storing the formed can at 50° C. and 98% RH for one month, no rust was generated. Consequently, the can of the Second Embodiment did not generate cracks on forming the bead, and performed sufficient corrosion resistance also in a humid environment.

Comparative Example is the same to that in the First Embodiment.

The two-piece can of the Second Embodiment is most suitable for the two-piece aerosol can owing to the superior performance. Other than the two-piece aerosol can, the two-piece can of the Second Embodiment is suitable for the uses which request the can strength, the corrosion resistance, the appearance, and the low manufacturing cost.

### THIRD EMBODIMENT

The laminated steel sheet as the base material in the Third Embodiment is the same as that in the previous embodiments.

The two-piece can of the Third Embodiment is formed by the steps of: using the laminated steel sheet as the base material; forming a can body in the shape of a cylinder integrated with bottom by applying repeated several cycles of drawing to a circular blank; applying diametral reduction to the can body at the opening side to a diameter smaller than the diameter of the can body, while satisfying the formulae (1) and (2); and forming a bead on the can body. Particularly in the Third Embodiment, the bead is formed by forming an upper bead at the opening side of the can body so that the tip of the opening curls outward from the can, and then by forming a lower bead so as to be connected to the root of the upper bead and to be bulged to project below the upper bead and in the shape of an arc in cross section outward the can.

1.5≦h/(R−r) (1)

d/R≦0.25 (2)

where, h is the height from the can bottom to the tip of the opening, R is the net blank radius, r is the radius of the can bottom, and d is the radius of the tip of the opening.

The forming method is described in more detail below.

The forming of can body in the shape of a cylinder integrated with a bottom, diametral reduction at the opening side of the can body and trimming after the diametral reduction are the same as those in the above description.

### (Forming the Bead)

In the Third Embodiment, the bead is formed by forming the upper bead at the opening side of the can body so that the tip of the opening curls outward from the can, and further by forming the lower bead to be connected to the root of the upper bead and to be bulged to project below the upper bead and in the shape of a circular arc in cross section outward the can. The procedure is the most important element in the Third Embodiment. By the procedure, the bead is formed without generating cracks, and the formed bead has a cross section of a vertically long elliptical shape as the total of the outer profile of the upper bead and the lower bead, which allows the mounting cap to clinch and fix to the can body, thereby allowing full functioning as the bead.

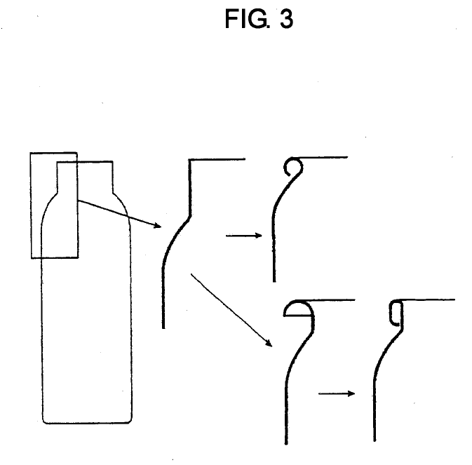

When the steel sheet is subjected to can-forming at a very high degree of working as in conventional technologies, the steel sheet is hardened by work-hardening, and the ductility thereof deteriorates. Therefore, when the opening end is treated by curling to form the bead, the opening end generates cracks, and the bead does not form after the diametral reduction on the can body in the shape of a cylinder integrated with a bottom. Furthermore, when the cross sectional shape of the bead is not in a simple circular arc shape, but in a vertically long elliptical shape, the forming of bead becomes more difficult. As illustrated in FIG. 3, on forming a bead having a cross section of a vertically long elliptical shape, conventional technologies adopt the method of forming a circular shape bead by curling as the first stage working, and then the bead is re-formed into the target vertically long elliptical shape as the second stage working. In that case, the radius of curvature in the first stage curling has to be larger than that of the vertically long ellipse, which increases the degree of working at the tip of the curled part, thus more likely inducing crack generation at the portion.

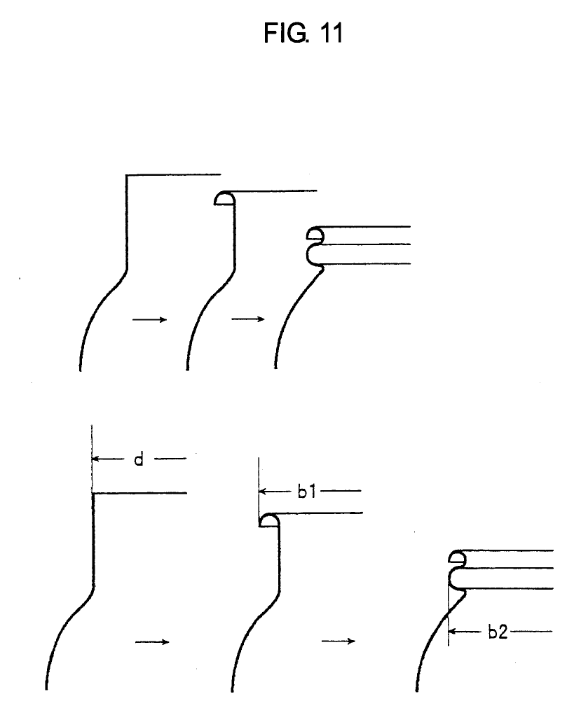

To this point, in the Third Embodiment, there was found the method of forming a bead curving outward in the radius direction of cylinder at the tip of the opening by forming an upper bead at the tip of the opening side, and then forming a lower bead to be positioned below the upper bead and to be connected to the root of the upper bead. The forming process and the shape of the bead are given in FIG. 11. According to FIG. 11, the upper bead curls outward from the can by the curling work at a small curvature not to induce generation of cracks at the opening end, and the lower bead is formed below the upper bead to be connected to the upper bead, and to be bulged in the shape of a circular arc in cross section outward from the can.

According to the Third Embodiment, the bead is formed by curling work at a small curvature not to induce generation of cracks during curling. In detail, curling is preferably conducted under the condition of b1/d≦1.4, (d is the radius of the tip of the opening after diametral reduction, and b1 is the outer diameter of the upper bead). If the condition becomes b1/d>1.4, the cracks likely appear.

Applicable methods for curling include the die-curling method which presses the opening end of the can body against a curling die having a circular arc shape curved face at the root of the cylinder insert, and the spinning method which presses the opening end against the roll having a circular arc-shaped curved face. As a typical example, an outline of forming by die-curling method is illustrated in FIG. 7.

Since the lower bead has a structure to fix the mounting cap by clinching thereof together with the upper bead, it is preferable that the outer profile drawn by the upper bead and the lower bead is in a vertically long elliptical shape as the total. To do this, it is preferable to conduct forming satisfying the relation of b2/b1=1, (b1 is the outer diameter of the upper bead, and b2 is the outer diameter of the lower bead).

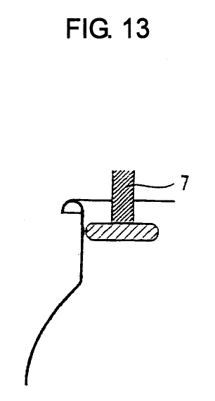

The method for forming the lower bead is not specifically limited if only the forming allows extending outward in the radius direction of the can body. However, the spinning method is preferable in terms of dimensional accuracy, which method conducts spinning from inside the can using a roll-shaped tool. In this case, it is also applicable that the forming is done in b2>b1 relation, followed by establishing the relation of b2/b1=1. An outline of the forming by the spinning method is given in FIG. 13. FIG. 13 shows the roll-shaped tool 7.

The cross sectional shape of the upper bead is roughly a circular arc. However, no strict limitation is applied to the shape of the upper bead if only fixing the mounting cap by clinching prevents leakage of the contents. To save the material, a half-circular cross section is preferred, as shown in FIG. 11. However, adoption of a circular arc circumferential length over a half circle can further increase the rigidity of the bead. FIG. 11 shows the outer diameter b1 of the upper bead, the outer diameter b2 of the lower bead, and the radius d of the tip of the opening.

The cross sectional shape of the lower bead is not specifically limited if only the lower end of the mounting cap is fully bent and caught-in at the moment of clinching and fixing the mounting cap. The lower bead is formed close to the upper bead. However, a gap may appear between the upper bead and the lower bead within a range to allow clinching depending on the size of the mounting cap.

The above procedure provides the two-piece can of the Third Embodiment. However, heat treatment and other working described below can be applied during the working process.

The heat treatment and other working applied during the working process are the same as those described before.

The structure of the bead specified in the First Embodiment is not limited to the case of laminated steel sheet as the can material, but also applicable to other base materials.

### EXAMPLE 3-1

A low carbon cold-rolled steel sheet having a 0.20 mm thickness obtained by continuous annealing process was adopted as the TFS original sheet, which sheet was then laminated on both sides thereof by a polyethylene terephthalate film having a 0.025 mm thickness by the thermal fusion method to prepare a laminated steel sheet. The laminated steel sheet was formed into a circular blank having an original blank radius R′ of 42 mm. Then, the blank was drawn at about 0.6 of the drawing rate. After that, four redrawing cycles at about 0.8 of the drawing rate were applied to form a can body in the shape of a cylinder integrated with a bottom having an 11 mm radius r of the can body. After forming a dome protruding inside of the can body at the can bottom by stretch forming, heat treatment was applied to the can body at 220° C. for 30 seconds. Further, trimming was applied to the tip of the opening of the can body, followed by applying a plurality of diametral reduction cycles at about 0.95 of the diametral reduction rate by the die-neck method to obtain a 7.5 mm opening radius d after diametral reduction. After the diametral reduction, the tip of the opening was further treated by trimming, thus forming a can having a 72 mm height h from the can bottom. The resulting net blank radius R became 40.3 mm, with the degree of working d/R in the circumferential direction, specified by the present invention, of 0.19, and the degree of working h/(R−r) in the height direction of 2.24.

The upper bead of the can body was formed at the root of the cylinder insert using the die-curling method which presses the opening end of the can body against the curling die having a curved part in circular arc shape with a 1.25 mm radius. The radius b1 of front end of the outer diameter of the upper bead was 10 mm, and b1/d was 1.2. Furthermore, the lower bead was formed at the can bottom side of the upper bead by the spinning working pressing a roll-shaped tool from inside the can, which lower bead bulged in a shape of a circular arc in cross section outward from the can. The tip radius b2 of the outer diameter of the lower bead was 10 mm. The bead height from the upper end of the upper bead to the lower end of the lower bead was 4 mm.

The above forming process did not generate cracks on forming particularly the bead. After storing the formed can at 50° C. and 98% RH for one month, no rust was generated. Consequently, the can did not generate crack on forming the bead, and performed sufficient corrosion resistance also in a humid environment.

Comparative Example is the same to that in the previous embodiments.

The two-piece can of the Third Embodiment is most suitable for the two-piece aerosol can owing to the superior performance. Other than the two-piece aerosol can, the two-piece can of the Third Embodiment is suitable for which need can strength, corrosion resistance, good appearance, and low manufacturing cost.

1. A two-piece can made of a laminated steel sheet, comprising: a can bottom functioning as a bottom plate and being positioned at a lowermost end of the can; a cylindrical can body having an opening positioned at an uppermost end of the can opposite the can bottom at the lowermost end and having a diametral reduction part positioned at an upper part of the can body and below the opening; and a bead which joins a cap outside the can and which is not integrated with the two-piece can with the opening positioned at the uppermost end of the can body, wherein the can body is worked in diametral reduction at an opening side to a diameter smaller than the diameter of the can body, while satisfying the formulae (1) and (2), and wherein the bead formed at the opening side of the can body is a bead curled outwardly from the can at a tip of the opening, and being curled in a circular arc in cross section thereof, and the bead is formed so that the tip of the curled bead to be curled in a circular arc in cross section inside the former circular arc in cross section on the same cross sectional plane,
1.5≦h/(R−r) (1)
d/R≦0.25 (2)
where, h is height from the can bottom to the tip of the opening, R is net blank radius, r is radius of the can bottom, and d is radius of the tip of the opening.

2. A two-piece can made of a laminated steel sheet comprising: a can bottom functioning as a bottom plate and being positioned at a lowermost end of the can; a cylindrical can body having an opening positioned at an uppermost end of the can opposite the can bottom at the lowermost end of the can and having a diametral reduction part positioned at an upper part of the can body and below the opening; and a bead which joins a cap outside the can and which is not integrated with the two-piece can with the opening positioned at the uppermost end of the can body, wherein the can body is worked in diametral reduction at an opening side to a diameter smaller than the diameter of the can body, while satisfying the formulae (1) and (2), and wherein the bead formed at the opening side of the can body is a bead curled outwardly from the can at a tip of the opening, and being curled in a vertically long ellipse in cross section thereof, and the bead is formed so that the tip of the curled bead to be curled in the vertically long ellipse in cross section and so that the elliptically curled tip is further curled in a circular arc in cross section on the same cross sectional plane,
1.5≦h/(R−r) (1)
d/R≦0.25 (2)
where, h is height from the can bottom to the tip of the opening, R is net blank radius, r is radius of the can bottom, and d is radius of the tip of the opening.

3. The two-piece can according to claim 1 or claim 2, wherein the bead is formed to satisfy b1/d≦1.4, where d is the radius of the tip of the opening, and b1 is the outer diameter of the bead.

4. A two-piece can made of a laminated steel sheet comprising: a can bottom functioning as a bottom plate and being positioned at a lowermost end of the can; a cylindrical can body having an opening positioned at an uppermost end of the can opposite the can bottom at the lowermost end of the can and having a diametral reduction part positioned at a upper part of the can body and below the opening; a bead which joins a cap outside the can and is not integrated with the two-piece can with the opening positioned at the uppermost end of the can body, wherein the can body is worked in diametral reduction at an opening side to a diameter smaller than the diameter of the can body, while satisfying the formulae (1) and (2); a bead which joins a mounting cap to the opening at a top of the can body, wherein the can body is worked in diametral reduction at the opening side to a diameter smaller than the diameter of the can body, while satisfying the formulae (1) and (2), and wherein the bead is formed so that the tip of the opening is curled outwardly from the can body at the opening side of the can body, and curled in a vertically long ellipse in cross section on the same cross sectional plane,
1.5≦h/(R−r) (1)
d/R≦0.25 (2)
where, h is height from the can bottom to the tip of the opening, R is net blank radius, r is radius of the can bottom, and d is radius of the tip of the opening.

5. The two-piece can according to claim 4, wherein the bead is formed to satisfy b1/d≦1.4, where d is the radius of the tip of the opening, and b1 is the outer diameter of the bead.

6. A two-piece can made of a laminated steel sheet comprising: a can bottom functioning as a bottom plate and being positioned at a lowermost end of the can; a cylindrical can body having an opening positioned at an uppermost end of the can opposite the can bottom at the lowermost end of the can and having a diametral reduction part positioned at an upper part of the can body and below the opening; a bead which joins a cap outside the can and is not integrated with the two-piece can with the opening positioned at uppermost end of the can body, wherein the can body is worked in diametral reduction at an opening side to a diameter smaller than the diameter of the can body, while satisfying the formulae (1) and (2), and wherein the bead comprises: an upper bead formed at the opening side of the can body and formed by curling the tip of the opening outward from the can; and a lower bead connected to a root of the upper bead and being formed below an adjacent position to the upper bead by bulging outside the can in an arc shape in cross section,
1.5≦h/(R−r) (1)
d/R≦0.25 (2)
where, h is height from the can bottom to the tip of the opening, R is net blank radius, r is radius of the can bottom, and d is radius of the tip of the opening.

7. The two-piece can according to claim 6, wherein the upper bead is formed to satisfy b1/d≦1.4, where d is the radius of tip of the opening and b1 is the outer diameter of the upper bead.

8. The two-piece can according to claim 7, wherein the lower bead is formed to satisfy b2/b1=1, where b1 is the outer diameter of the upper bead and b2 is the outer diameter of the lower bead.

9. The two-piece can according to any of claims 1, 2, 4, and 6, wherein the laminated steel sheet is a steel sheet laminated by a polyester resin.

10. The two-piece can according to claim 9, the polyester resin is prepared by polycondensation of a dicarboxylic acid component and a diol component, wherein the dicarboxylic acid component contains terephthalic acid as a main ingredient, and the diol component contains ethylene glycol and/or butylene glycol as a main ingredient.

11. The two-piece can according to claim 10, further comprising an organic resin as the laminate of the laminated steel sheet, which organic resin contains a polyester resin as a main phase, and a resin which is incompatible and has 5° C. or lower Tg as a sub-phase.

12. The two-piece can according to claim 11, wherein the resin existing as the sub-phase is at least one resin selected from the group consisting of polyethylene, an acid modification thereof, an ionomer thereof, polypropylene, an acid modification thereof, and an ionomer thereof.

13. A laminated steel sheet for two-piece can, comprising an organic resin film as the laminate for forming the two-piece can according to any of claims 1, 2, 4, and 6.

14. A method of forming two-piece can made of a laminated steel sheet, comprising: forming a can body in a shape of a cylinder integrated with a bottom by applying repeated cycles of drawing to a circular blank; applying diametral reduction to the can body at an opening end side to a diameter smaller than the diameter of the can body, while satisfying the formulae (1) and (2); and forming a bead by forming a first curled part by curling a tip of the opening of the can body outwardly from the can in a circular arc in cross section, followed by forming a second curled part by curling a tip of the opening containing the first curled part in a circular arc in cross section,
1.5≦h/(R−r) (1)
d/R≦0.25 (2)
where, h is height from the can bottom to the tip of the opening, R is net blank radius, r is radius of the can bottom, and d is radius of the tip of the opening.

15. A method of forming two-piece can made of a laminated steel sheet, comprising: forming a can body in a shape of a cylinder integrated with a bottom by applying repeated cycles of drawing to a circular blank; applying diametral reduction to the can body at an opening side to a diameter smaller than the diameter of the can body, while satisfying the formulae (1) and (2); and forming a bead by forming a first curled part by curling a tip of an opening of the can body outwardly from the can in a circular arc in cross section, followed by forming a second curled part by curling a tip of the opening containing the first curled part in a circular arc in cross section, and then by pressing the curled part inwardly into the can to create a vertically long ellipse in cross section,
1.5≦h/(R−r) (1)
d/R≦0.25 (2)
where, h is height from the can bottom to the tip of the opening, R is net blank radius, r is radius of the can bottom, and d is radius of the tip of the opening.

16. A method of forming two-piece can made of a laminated steel sheet, comprising: forming a can body in a shape of a cylinder integrated with a bottom by applying repeated cycles of drawing to a circular blank; applying diametral reduction to the can body at an opening side to a diameter smaller than the diameter of the can body, while satisfying the formulae (1) and (2); and forming a bead by forming a first curled part by curling a tip of an opening of the can body outwardly from the can in a circular arc in cross section, followed by forming a second curled part in a vertically long ellipse in cross section by pressing a tip of the opening of the first curled part downwardly toward the can bottom,
1.5≦h/(R−r) (1)
d/R≦0.25 (2)
where, h is height from the can bottom to the tip of the opening, R is net blank radius, r is radius of the can bottom, and d is radius of the tip of the opening.

17. A method of forming two-piece can made of a laminated steel sheet, comprising: forming a can body in a shape of a cylinder integrated with a bottom by applying repeated cycles of drawing to a circular blank; applying diametral reduction to the can body at an opening end side to a diameter smaller than the diameter of the can body, while satisfying the formulae (1) and (2); and on forming a bead, forming an upper bead at the opening side of the can body so that a tip of the opening is curled outwardly from the can, and forming a lower bead connecting to a root of the upper bead so that the lower bead bulges outwardly from the can in an arc in cross section below the upper bead, thus obtaining the two-piece can,
1.5≦h/(R−r) (1)
d/R≦0.25 (2)
where, h is height from the can bottom to the tip of the opening, R is net blank radius, r is radius of the can bottom, and d is radius of the tip of the opening.

18. The method according to any of claims 14, 15, 16, and 17, further comprising forming the upper bead satisfying b1/d≦1.4, where d is the radius of the tip of the opening, and b1 is the outer diameter of the bead.

19. The method according to claim 17, further comprising forming the lower bead satisfying b2/b1=1, where b1 is the outer diameter of the upper bead and b2 is the outer diameter of the lower bead.

20. The method according to any of claims 14, 15, 16, and 17, wherein the laminated steel sheet is a steel sheet laminated by a polyester resin.

21. The method according to claim 20, wherein the polyester resin is prepared by polycondensation of a dicarboxylic acid component and a diol component, wherein the dicarboxylic acid component contains terephthalic acid as a main ingredient, and the diol component contains ethylene glycol and/or butylene glycol as a main ingredient.

22. The method according to claim 21, further comprising an organic resin as the laminate of the laminated steel sheet, which organic resin contains the polyester resin as a main phase, and a resin which is incompatible and has 5° C. or lower Tg as a sub-phase.

23. The method according to claim 22, wherein the resin existing as the sub-phase is at least one resin selected from the group consisting of polyethylene, an acid modification thereof, an ionomer thereof, polypropylene, an acid modification thereof, and an ionomer thereof.

24. The method according to any of claims 14, 15, 16, and 17, further comprising adding ironing to the deep drawing.

25. The two-piece can according to any of claims 1, 2, 4, and 6, wherein the steel sheet as a substrate of the laminated steel sheet contains at least one of the following:
(1) a steel sheet of a low carbon steel of approximate range from 0.01 to 0.10% C, prepared by recrystallization annealing by box annealing;
(2) a steel sheet of a low carbon steel of approximate range from 0.01 to 0.10% C, prepared by recrystallization annealing by continuous annealing;
(3) a steel sheet of a low carbon steel of approximate range from 0.01 to 0.10% C, prepared by recrystallization annealing by continuous annealing, followed by over-aging;
(4) a steel sheet of a low carbon steel of approximate range from 0.01 to 0.10% C, prepared by recrystallization annealing by box annealing or continuous annealing, followed by secondary cold-rolling (cold-rolling after annealing); and
(5) an IF steel (interstitial free steel) of a very low carbon steel of approximate range of 0.003% or less C with the addition of solid-solution C-fixing element, prepared by recrystallization by continuous annealing.

26. The method according to any of claims 14, 15, 16, and 17, wherein the diametral reduction of the laminated steel sheet is at least one of die-curling method and spinning method.
